(19) United States
(12) Patent Application Publication
(10) Pub. No.: US 2003/0111825 A1
(43) Pub. Date: Jun. 19, 2003

(54) Stroller frame for coupling a safety seat

(76) Inventors: Kun-Chang Lo, Chiai (TW); Hung-Chung Hou, Chiai (TW)

Correspondence Address: BIRCH STEWART KOLASCH & BIRCH, PO BOX 747, FALLS CHURCH, VA, 22040-0747, US

(21) Appl. No.: 10/310,933

(22) Filed: Dec. 6, 2002

(30) Foreign Application Priority Data
Dec. 14, 2001 (TW) 090221927

(51) Int. Cl. B62B 1/00

(52) U.S. Cl. 280/642

(57) ABSTRACT

A stroller frame for coupling a safety seat has the safety seat straddled and confined between the stroller frame without moving sidewards. The stroller frame has a bottom tube extending to form a support tube to wedge in and latch on the bottom end of one side of the stroller frame to support one side of the safety seat and restrict the safety seat from moving forwards and rearwards. Thus the safety seat may be mounted securely on the stroller frame in a straddle manner.

### FIELD OF THE INVENTION

The invention relates to a stroller frame for coupling a safety seat that has a holding structure to support a safety seat in a straddle manner.

### BACKGROUND OF THE INVENTION

Safety seats are products especially designed for seating a small child in a car. As car accident is one of the main causes of injury to small children, and the safety car seat can effectively reduce such suffering, hence when carrying a small child in the car, a safety seat must be setup to accommodate the child. In addition, the safety seat must be selected according to the age and physical size of the child to ensure effective protection for the child.

To avoid the inconvenience of carrying the safety seat, there are products on the market for coupling the safety seat to a stroller so that the safety seat not only can be used in the car but also may be directly mounted onto the stroller for moving the safety seat as desired. U.S. Pat. Nos. 5,772,279, 5,947,555 and 5,865,447 disclose strollers that can couple with a safety seat. They mainly provide armrests to hold and support the safety seat thereby to save the trouble of carrying the safety seat separately.

The present strollers that can couple with a safety seat mostly use the armrests to support the safety seat. However not all strollers are designed with suitable armrests (to support the safety seat).

### SUMMARY OF THE INVENTION

In view of the aforesaid disadvantages, the primary object of the invention is to provide a stroller frame for coupling a safety seat that is simply constructed and easy to use.

The stroller frame for coupling a safety seat according to the invention mainly includes a bottom tube which is extended to form a support tube to wedge in and latch on the bottom end of one side of the safety seat to support one side of the safety seat and restrict the safety seat from moving forwards and rearwards so that the safety seat is firmly mounted on the stroller frame in a straddle manner.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the stroller frame and the safety seat of the invention.

FIG. 2 is a perspective view of the stroller frame and the safety seat of the invention.

FIG. 3 is an exploded view of the support rack and the handle tube of the stroller frame of the invention.

FIG. 3A is a fragmentary enlarged view of FIG. 3.

FIG. 4 is a fragmentary sectional view of support tune and the handle tube according to the invention.

FIG. 5 is a schematic sectional view of the support rack in a moving condition.

FIG. 6 is a schematic sectional view of the support rack in another moving condition.

### DESCRIPTION OF THE PREFERRED EMBODIMENT

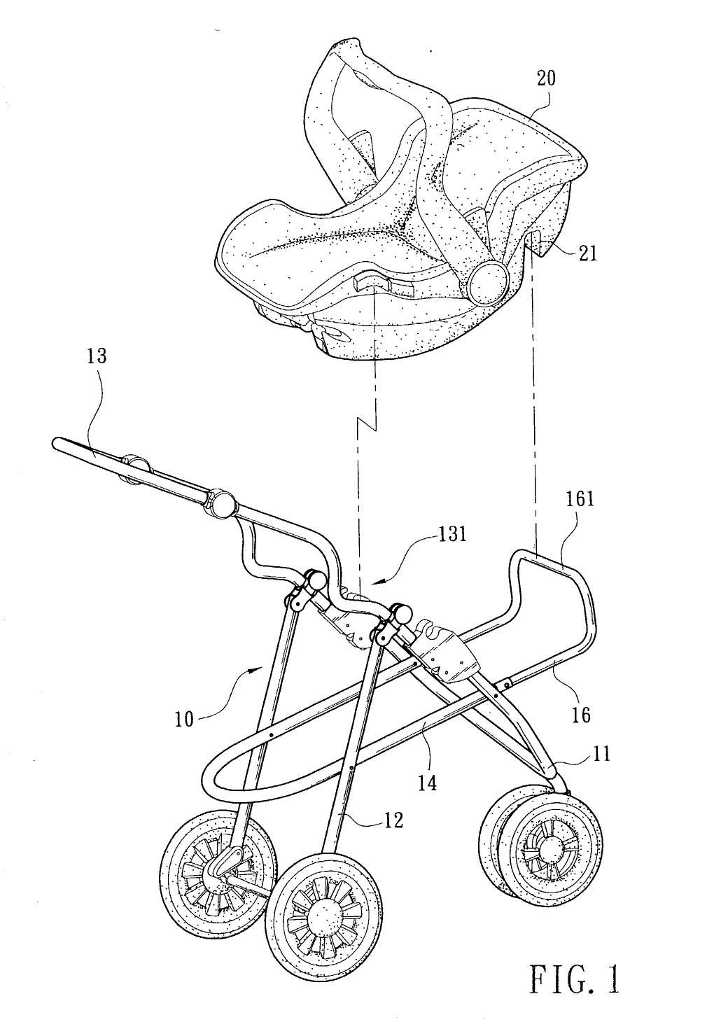

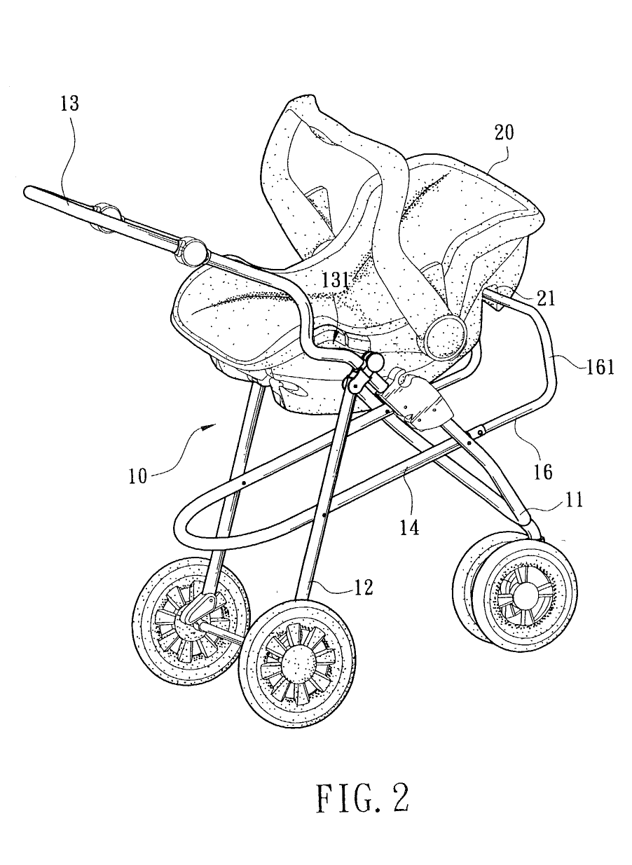

Referring to FIGS. 1 and 2, the invention provides a stroller frame 10 to enable a safety seat 20 to mount thereon in a straddle manner so that the safety seat 20 may be moved with the stroller frame 10. The safety seat 20 has a sitting space for seating a small child. The safety seat 20 generally is located in a car. It has at least one latch trough 21 formed on the bottom side of one end thereof.

As shown in the preferred embodiment in the drawings, the stroller frame 10 includes a front leg tube 11, a rear leg tube 12, a handle tube 13 and a bottom tube 14. The stroller frame 10 is slightly wider than the width of the safety seat 20 so that the safety seat 20 may be held between the stroller frame 10. The handle tube 13 is bent at a desired location to form a support section 131 to hold one end of the safety seat 20. As shown in the drawings, the support section 131 may be formed by bending the handle tube 13 upwards with an arched section.

The bottom tube 14 has one end connecting to a support rack 16. The support rack 16 has one end bending upwards to form an inserting section 161 to wedge in and latch on the latch trough 21 of the safety seat 20 for holding another end of the safety seat 20.

By means of the foregoing structure, the safety seat 20 is nestled between the stroller frame 10 with one end straddling the support section 131, and is confined by the stroller frame 10 from moving sidewards, and has another end with the latch trough 21 latched on the inserting section 161 of the support rack 16 to be prohibited from moving forwards and rearwards. In other words, the safety seat 20 is mounted on the support section 131 and the support rack 16 in a straddle manner, and is confined securely without moving sidewards and forwards and rearwards. Thus when the stroller frame 10 is moved, the safety seat 20 coupled on the stroller frame 10 may also be moved together.

In addition, the stroller 10 or the safety seat 20 may have a strap (not shown in the drawings) to fasten to one end of the safety seat 20. In such a circumstance, the support section 131 on the stroller 10 may be dispensed with.

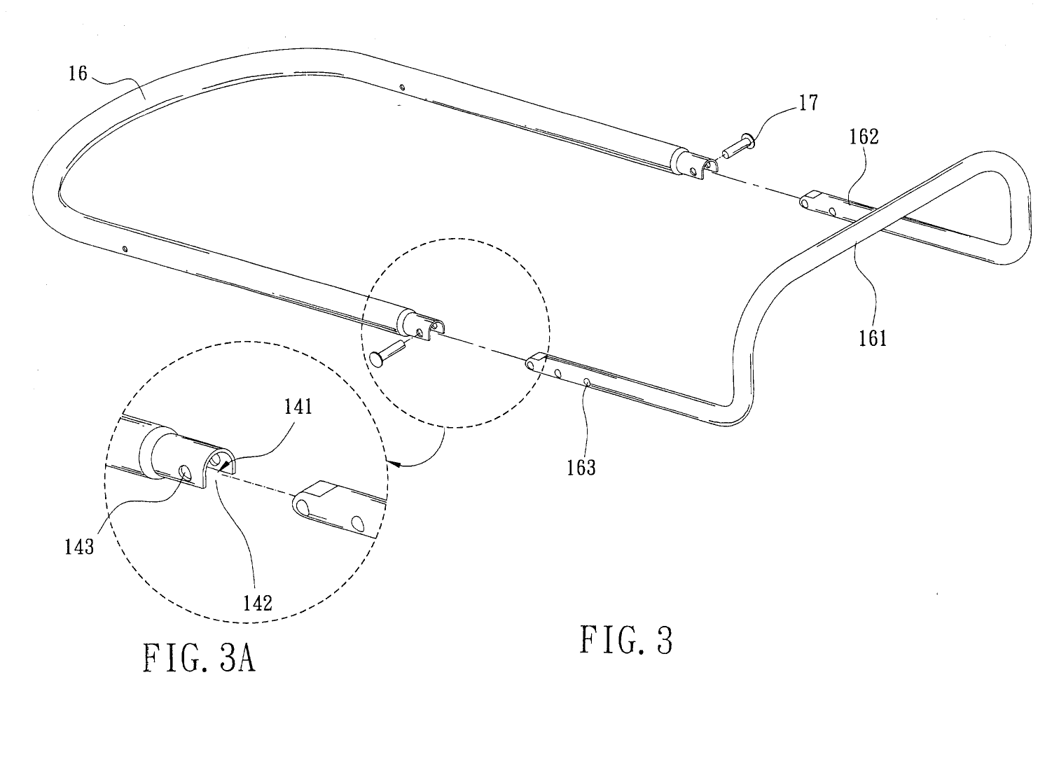

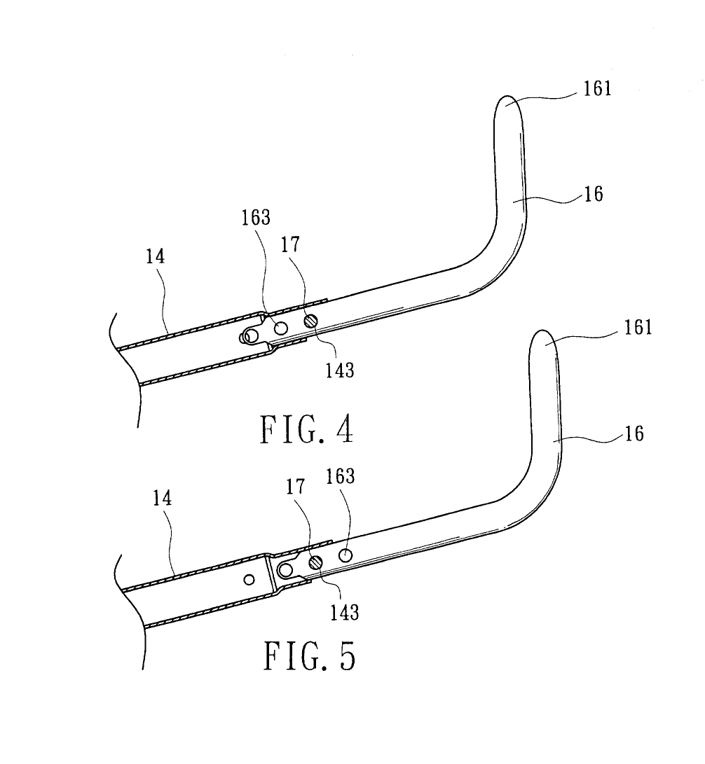

Refer to FIGS. 3, 3A and 4 for the coupling relationship between the bottom tube 14 and the support rack 16. The bottom tube 14 has a front end with an insert opening 141 to receive the support rack 16, a slot 142 forming at one side of the insert opening 141, and a radial aperture 143 forming on an outer side thereof. The support rack 16 has two side ends 162 for coupling with the insert openings 141. Each side end 162 has a plurality of anchor holes 163. Any one of the anchor holes 163 may be aligned with the aperture 143 to allow an anchor pin 17 to run through and fasten the side end 162 in the insert opening 141.

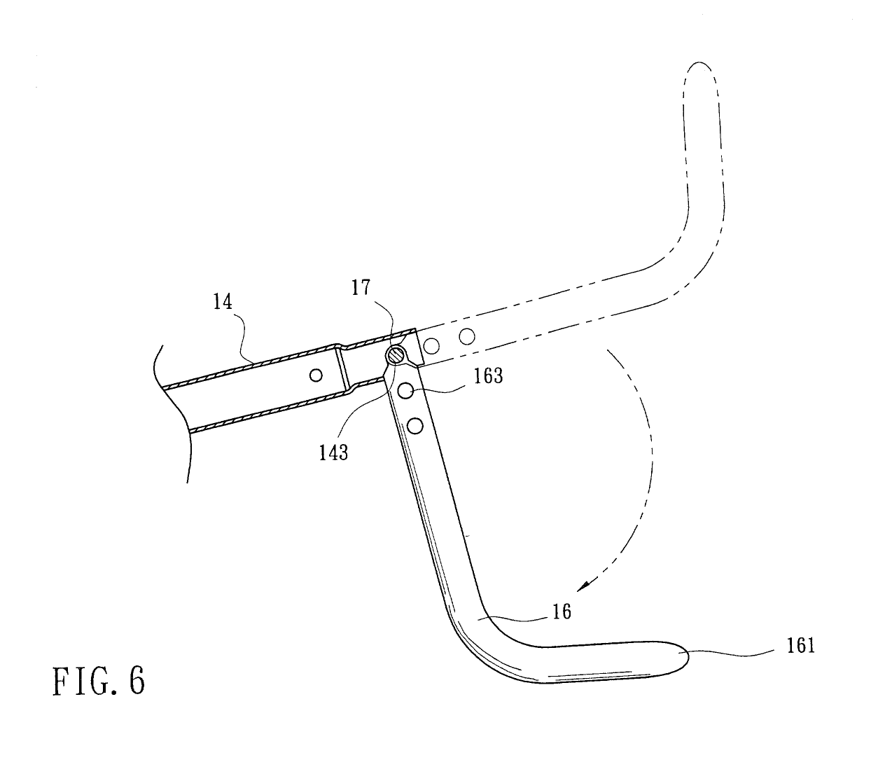

Referring to FIGS. 5 and 6, the support rack 16 may be coupled in the insert opening 141 through the side end 162. The side end 162 has a plurality of anchor holes 163. By coupling the anchor pin 17 through different anchor holes 163 through the aperture 143, the depth of the side end 162 inside the insert opening 141 may be adjusted and consequently alter the location of the support rack 16 to fit the latch trough 21 of the safety seat 20.

Moreover, the anchor hole 163 adjacent to the distal end of the side end 162 may also be aligned with the aperture 143 and coupled with the anchor pin 17 so that the entire support rack 16 may be turned about the anchor pin 17 and pass through the slot 142 to lean on the end of the slot 142. By means of such an arrangement, the support rack 16 has a first position not engaging with the safety seat 20 and a second position engaging with the safety seat 20. At the first position, the support rack 16 may serve as a foot pedal for the child sitting on the stroller frame 10. At the second position, the support rack 16 is wedged in the latch trough 21 of the safety seat 20.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A stroller frame for coupling a safety seat comprising a front leg tube, a rear leg tube, a handle tube and a bottom tube for holding a safety seat in a straddle manner, the bottom tube being extended to form a support tube for wedging in a bottom end of one side of the safety seat to support one side of the safety seat.

2. The stroller frame for coupling a safety seat of claim 1, wherein the stroller frame has a support section corresponding to the support tube to allow another side of the safety seat mounting thereon in a straddle manner thereby to confine the safety seat between the stroller frame without moving sideward.

3. The stroller frame for coupling a safety seat of claim 1, wherein the safety seat has a latch trough formed on the bottom end of one side thereof to allow the support tube to wedge in when the safety seat is straddled on the stroller frame to restrict the safety seat from moving forwards and rearwards.

4. A stroller frame for coupling a safety seat comprising a front leg tube, a rear leg tube, a handle tube and a bottom tube for holding a safety seat in a straddle manner, the stroller frame having a movable support tube located on a front end thereof, the support tube having a first position not engaging with the safety seat and a second position engaging with the safety seat, the support tube at the first position being served as a foot pedal for a child sitting of the stroller frame, and the support tube at the second position being inserted and latched on a bottom end of one side of the safety seat.

5. The stroller frame for coupling a safety seat of claim 4, wherein the stroller frame has a support section corresponding to the support tube to allow another side of the safety seat mounting thereon in a straddle manner thereby to confine the safety seat between the stroller frame without moving sidewards.

6. The stroller frame for coupling a safety seat of claim 4, wherein the safety seat has a latch trough formed on the bottom end of one side thereof to allow the support tube to wedge in when the safety seat is straddled on the stroller frame to restrict the safety seat from moving forwards and rearwards.
